(19) United States
(12) Patent Application Publication
(10) Pub. No.: US 2015/0298295 A1
(43) Pub. Date: Oct. 22, 2015

(54) FOLDING KNIFE WITH BUILT IN SHARPENER

(71) Applicant: JASON LEE LANDON, WEATHERFORD, TX (US)

(72) Inventor: JASON LEE LANDON, WEATHERFORD, TX (US)

(21) Appl. No.: 14/609,157

(22) Filed: Jan. 29, 2015

Related U.S. Application Data
(60) Provisional application No. 61/932,942, filed on Jan. 29, 2014.

(51) Int. Cl. B24D 15/08; B26B 11/00; B26B 1/02

(52) U.S. Cl. CPC B24D 15/084; B26B 1/02; B26B 11/00

(57) ABSTRACT

Disclosed embodiments include a folding knife having a blade with a tip, a heel, and a cutting edge that extends from the tip to the heel. The folding knife also has a handle with an outer surface having at least one slot and a sharpener assembly having at least one sharpener element and at least one stud positioned in the at least one slot and that is graspable on the outer surface of the handle. Further, movement of the stud through the slot causes the sharpener assembly to traverse the blade along the cutting edge from the tip to the heel, or from the heel to the tip, and causes the at least one sharpener element to engage the blade.

### CROSS-REFENENCE TO RELATED APPLICATIONS

This application, under 35 U.S.C. §119, claims the benefit of U.S. Provisional Patent Application Ser. No. 61/932,942 filed on Jan. 29, 2014, and entitled “Folding Knife With Sharpener Built In,” the contents of which are hereby incorporated by reference herein.

### FIELD OF THE DISCLOSURE

This disclosure relates generally to knives and knife sharpening. In particular, embodiments of a folding knife with a built-in sharpener are disclosed.

### BACKGROUND

Sharpening a knife can often be difficult or inconvenient for a variety of reasons. For example, the knife user may be “in the field” and not have access to sharpening tools. Likewise, without significant practice or skill it is often difficult to hold the sharpener at proper angle or create a good edge in order to make the knife blade sharp. Therefore, for these and other reasons, it is desirable to have a knife with an integral sharpener that is convenient and easy to use.

Some prior knives have included an integral sharpener, but typically only sharpen a portion of the blade and not the entire blade. In addition, existing integral sharpeners often require the blade to be partially open when being sharpened which can be dangerous and undesirable.

In addition, some existing integral sharpeners do not provide a way to keep the sharpener out of the way during other use of the knife. Other integral sharpeners do not allow for any change in the sharpening angle for the knife edge. Other drawbacks of prior systems may also exist.

### SUMMARY

Accordingly, the disclosed embodiments address the above noted and other drawbacks of existing systems. Some disclosed embodiments comprise a folding knife comprising a blade comprising a tip, a heel, and a cutting edge that extends from the tip to the heel. The folding knife further comprises a handle comprising an outer surface having at least one slot and a sharpener assembly comprising at least one sharpener element and at least one stud positioned in the at least one slot and that is graspable on the outer surface of the handle. Further, movement of the stud through the slot causes the sharpener assembly to traverse the blade along the cutting edge from the tip to the heel, or from the heel to the tip, and causes the at least one sharpener element to engage the blade.

Other embodiments comprise a lock positioned in the handle and configured to selectively hold the sharpener assembly at a predetermined location.

Still other embodiments comprise a knife comprising a blade comprising a curved cutting edge and a handle comprising at least one slot shaped to substantially conform to the shape of the curved cutting edge. Embodiments further comprise a sharpener assembly configured to engage the at least one slot and thereby traverse the curved cutting edge of the blade.

Still other embodiments comprise a sharpener for a folding knife comprising a sharpener assembly comprising at least one stud configured to engage a slot in a knife handle and at least one sharpener element positioned in the sharpener assembly. Further, the slot in the knife handle is shaped to correspond to a shape of a knife blade. In some embodiments, the sharpener is integral with the knife handle. Other advantages and features for the disclosed embodiments are provided below.

### BRIEF DESCRIPTION OF THE DRAWINGS

FIG. 1 is an isometric view of a folding knife in the closed position in accordance with disclosed embodiments.

FIG. 2 is an isometric view of folding knife in the open position in accordance with disclosed embodiments.

FIG. 3 is an isometric view of folding knife in the open position showing additional features of disclosed embodiments.

FIG. 4 is a top-down view of the bottom side of the folding knife in open position in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

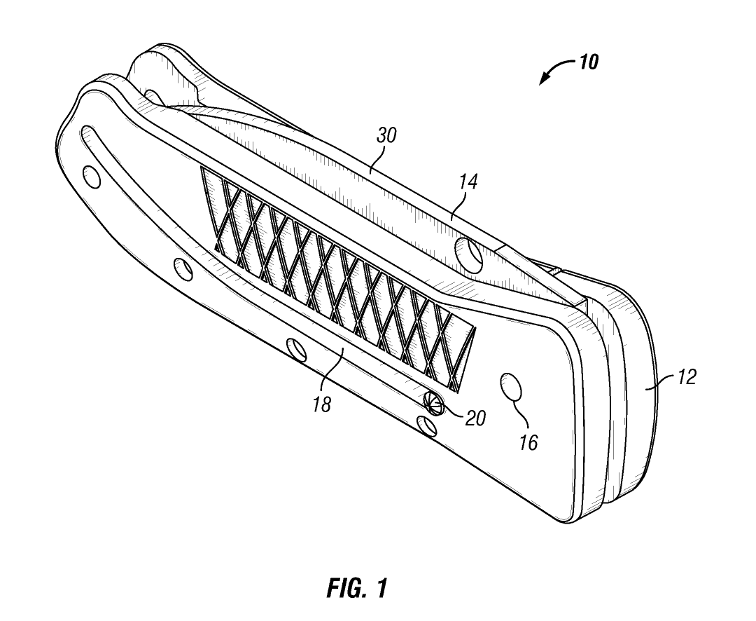

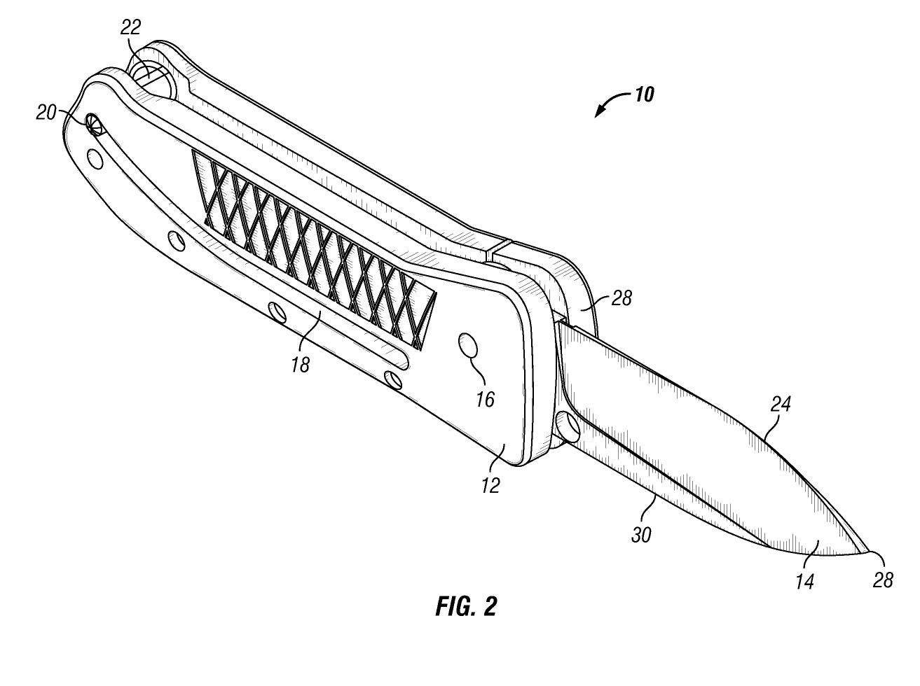

FIG. 1 is an isometric view of a folding knife 10 in closed position in accordance with disclosed embodiments. As shown, embodiments of a folding knife 10 typically include a handle 12 and a blade 14. Folding knife 10 may also include a pivot 16 about which the blade 14 may be unfolded or opened outwardly into a useable or open position (as shown, for example, in FIG. 2). As discussed below, blade 14 may also pivot about pivot 16 in the opposite direction (i.e., inwardly) in order to move further into handle 12 and engage the sharpener assembly 22 (not visible in FIG. 1).

As also shown in FIG. 1, handle 12 may comprise one or more grooves or slots 18 cut into the side of the handle 12. While FIG. 1 shows slot 18 extending completely through the side of handle 12 it need not be. One purpose of slot 18 is to provide a path for sharpener assembly 22 to reliably and repeatedly traverse when sharpening the blade 14. To that end, embodiments of folding knife 10 have one or more slots 18 shaped so as to substantially correspond to the shape of the cutting edge 24 of blade 14 and thereby cause sharpener assembly 22 to engage the cutting edge 24 of blade 14 and sharpen the entire length of the cutting edge 24.

FIG. 1 also shows studs 20 that for some embodiments enable the user to manipulate the sharpener assembly 22 and cause it to move back and forth along the blade 14. While FIG. 1 shows the studs 20 as being generally round in cross-section, they need not be and other shapes, textures, and sizes are possible.

FIG. 2 is an isometric view of folding knife 10 in the open position in accordance with disclosed embodiments. As shown in FIG. 2, when pivoted outwardly blade 14 is put into a usable position with cutting edge 24 available for use.

As also shown in FIG. 2, sharpener assembly 22 is movable along slot 18 and has been positioned at one end of handle 12. Again, while FIG. 2 shows slot 18 extending completely through handle 12, it need not, and other embodiments may employ a single slot 18, double slots 18, or grooves, channels, indents, tracks, or the like, instead of through slots 18. As also shown, blade 14 may comprise a tip 26, a heel 28, and a spine 30, and have a curved cutting edge 24. As noted above, the shape of slot 18 is meant to substantially mirror the curve of cutting edge 24 so that sharpener assembly 22 may traverse the cutting edge 24 from tip 26 to heel 28, and vice versa, and thereby sharpen the entire cutting edge 24. While a particular curve for cutting edge 24 and slot 18 is shown in the figures, other curves are also possible depending upon the type of blade 14 desired.

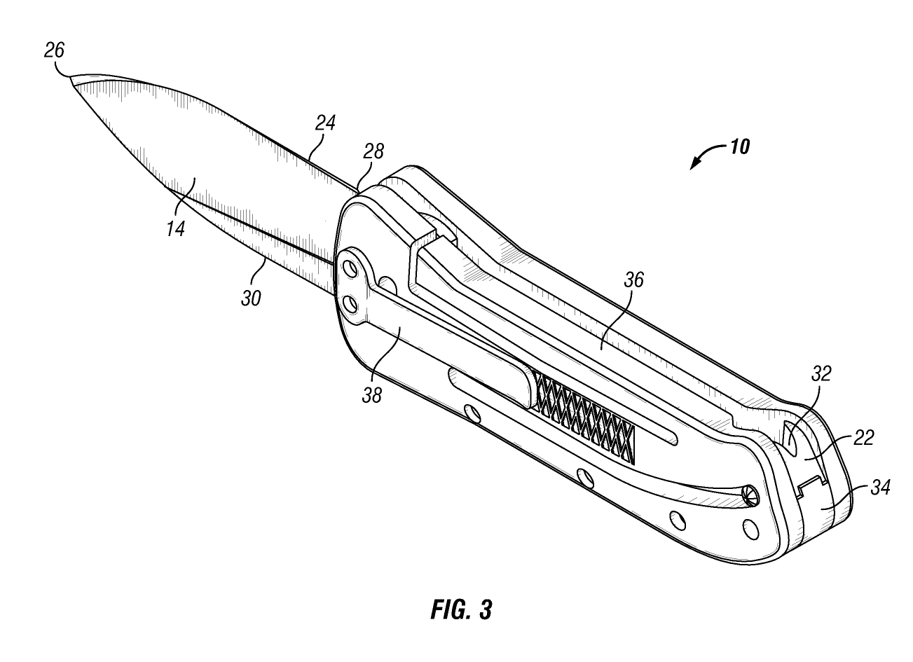

FIG. 3 is an isometric view of folding knife 10 in the open position showing additional features of disclosed embodiments. As shown, embodiments of sharpener assembly 22 may comprise a substantially v-shaped groove 32. Groove 32 is shaped to give the cutting edge 24 the desired bevel angle for the blade 14. For example, if a bevel angle of 25° is desired, groove 24 is shaped so that the opposing sides will form a 25° bevel angle in cutting edge 24 of blade 14. Other bevel angles are also possible. In some embodiments, sharpener assembly 22 may be replaceable with other sharpener assemblies 22 having differing grooves 32 to allow sharpening with an assortment other bevel angles.

In some embodiments, sharpener assembly 22 may be shaped to mate with a corresponding track 34. For example, sharpener assembly 22 may have a groove shaped portion that mates with a tongue shaped portion in track 34. Other shapes are also possible. The mating portions facilitate, among other things, the correct path of travel for sharpener assembly 22 when sharpening.

Embodiments of the folding knife 10 may optionally and selectively lock blade 14 into open position as is known in the art. For example, as illustrated in FIG. 3, folding knife 10 may comprise a lever 36 or the like that springs in behind the blade 14 when opened and locks the blade 14 in place. Lever 36 is typically referred to as a liner lock.

As also shown in FIG. 3, folding knife 10 may optionally have a clip 38 or other mechanism to facilitate carrying of the knife 10 by, for example, enabling attachment to a belt or pocket. Other attachment mechanisms are also possible.

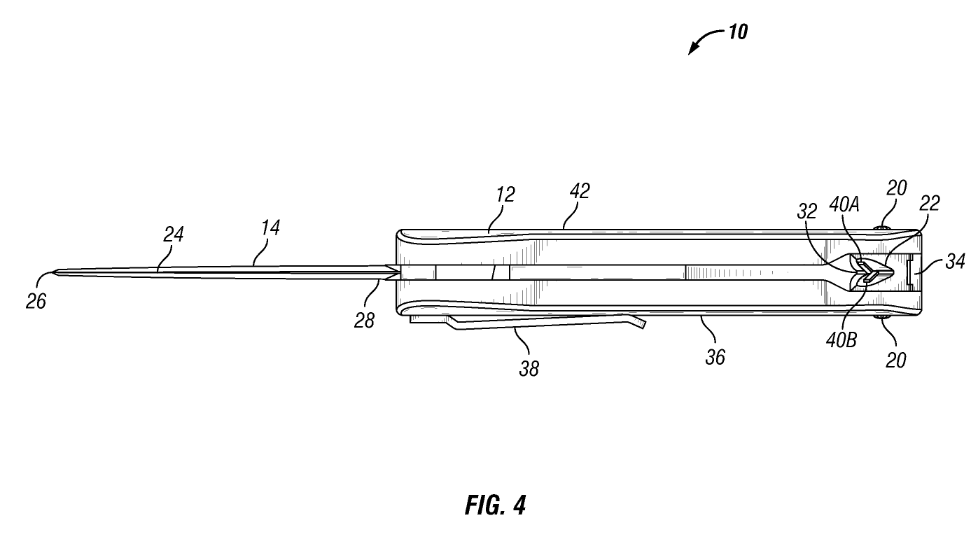

FIG. 4 is a top-down view of the bottom side of the folding knife 10 in open position in accordance with disclosed embodiments. As shown in FIG. 4 sharpener assembly 22 may also comprise one or more sharpener elements 40A and 40B. Sharpener elements 40A, 40B are the surfaces that grind or otherwise abrade the blade 14 to form a sharp cutting edge 24 and may comprise any suitable sharpening element such as stone, diamond, ceramics, carbide steel, abrasives, abrasive impregnated leather, or the like. As shown sharpener elements 40A, 40B may be mounted on opposing sides of groove 32 in order to contact opposite sides of blade 14. Other configurations are also possible.

As also shown in FIG. 4, embodiments of folding knife 10 may comprise a lock to hold sharpener assembly 22 in a preferred position when not in use. For example, a detent ball (not visible) may be mounted in a surface of sharpener assembly 22 and it may mate with detent hole 42 to releaseably hold sharpener assembly 22 in place. Of course, configuration of the detent ball and hole 42 may also be reversed (i.e., ball in handle 12 and hole 42 in sharpener assembly 22). Other locking mechanisms for sharpener assembly 22 are also possible.

As is apparent from the above description, embodiments of folding knife 10 may be operated to sharpen the blade 14 as follows. The folding knife 10 is put into closed position (e.g., FIG. 1). Sharpener assembly 22 may be moved out of a locked position by grasping studs 20 and pulling the sharpener assembly 22 along track 34 by moving studs 20 through slots 18. Sharpener elements 40A, 40B will engage blade 14 on both sides and grind or otherwise abrade the blade at a bevel angle defined by groove 32. Slots 18 and track 34 are shaped so that the sharpener assembly 22 travels the entire length of blade 14 from heel 28 to tip 26 and follows the curve of the blade 14. The process may be repeated (from tip 26 to heel 28 and back again) as many times as desired to achieve a sharp cutting edge 24. In this manner the entire length of the cutting edge 24 may be sharpened.

In some embodiments, it may be desirable to first push the spine 30 inwardly to cause the blade 14 to engage the sharpener assembly 22. In other embodiments the sharpener assembly 22 will engage the blade 14 without any inward movement of the blade.

Although various embodiments have been shown and described, the present disclosure is not so limited and will be understood to include all such modifications and variations are would be apparent to one skilled in the art.

What is claimed is:

1. A folding knife comprising:
a blade comprising a tip, a heel, and a cutting edge that extends from the tip to the heel;
a handle comprising an outer surface having at least one slot;
a sharpener assembly comprising at least one sharpener element and at least one stud positioned in the at least one slot and that is graspable on the outer surface of the handle; and
wherein movement of the stud through the slot causes the sharpener assembly to traverse the blade along the cutting edge from the tip to the heel, or from the heel to the tip, and causes the at least one sharpener element to engage the blade.

2. The folding knife of claim 1 further comprising
a lock positioned in the handle and configured to selectively hold the sharpener assembly at a predetermined location.

3. A knife comprising:
a blade comprising a curved cutting edge;
a handle comprising at least one slot shaped to substantially conform to the shape of the curved cutting edge;
a sharpener assembly configured to engage the at least one slot and thereby traverse the curved cutting edge of the blade.

4. A sharpener for a folding knife comprising:
a sharpener assembly comprising at least one stud configured to engage a slot in a knife handle;
at least one sharpener element positioned in the sharpener assembly; and
wherein the slot in the knife handle is shaped to correspond to a shape of a knife blade.

5. The sharpener of claim 4 wherein the sharpener is integral with the knife handle.
